(19) United States
(12) Patent Application Publication
(10) Pub. No.: US 2025/0167875 A1
(43) Pub. Date: May 22, 2025

(54) METHOD AND DEVICE FOR DATA TRANSMISSION IN WIRELESS COMMUNICATION SYSTEM

(71) Applicant: Samsung Electronics Co., Ltd., Suwon-si, Gyeonggi-do (KR)

(72) Inventors: Zhe CHEN, Beijing (CN); Bin YU, Beijing (CN); Feifei SUN, Beijing (CN)

(21) Appl. No.: 18/841,581

(22) PCT Filed: Feb. 23, 2023
(86) PCT No.: PCT/KR2023/002567

§ 371 Date: Aug. 26, 2024

(30) Foreign Application Priority Data
Mar. 9, 2022 (CN) 202210225570.5

(51) Int. Cl. H04B 7/155; H04L 5/00

(52) U.S. Cl. CPC H04B 7/15542; H04L 5/0048

(57) ABSTRACT

The disclosure relates to a 5G or 6G communication system for supporting a higher data transmission rate. The disclosure provides a method and a device for receiving and transmitting information. Specifically, method and device according to the present disclosure discloses a method performed by a repeater in a wireless communication network, which comprises: receiving reference signal information from a base station; and receiving signal and/or forwarding signal in time domain resources related to at least one of the reference signals, wherein at least one of the reference signals is related to the reference signal information. Further disclosed a method performed by a repeater in a wireless communication network, which comprises: receiving time domain resource information from a base station; and receiving signal and/or forwarding signal in at least one of the time domain resources, wherein at least one of the time domain resources is related to the time domain resource information.

### TECHNICAL FIELD

The application relates to the technical field of wireless communication, and more particularly to a method and device for data transmission in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present disclosure provides a method and apparatus for data transmission in a wireless network system.

### Solution to Problem

According to an aspect of an exemplary embodiment, there is provided a communication method in a wireless communication system.

### Advantageous Effects of Invention

Aspects of the present disclosure provide efficient communication methods in a wireless communication system.

### BRIEF DESCRIPTION OF DRAWINGS

The above and other aspects, features and advantages of the present invention will become more apparent from the following detailed description when taken in conjunction with the accompanying drawings.

FIG. 1 illustrates the structure of a 5G wireless communication system including a repeater;

FIG. 2 illustrates the structure of a 5G wireless communication system including a repeater according to an embodiment of the present disclosure;

FIG. 3 illustrates an example of source beam definition according to an embodiment of the present disclosure;

FIG. 4 illustrates another example of source beam definition according to an embodiment of the present disclosure;

FIG. 5 illustrates another example of source beam definition according to an embodiment of the present disclosure;

FIG. 6 illustrates another example of source beam definition according to an embodiment of the present disclosure;

FIG. 7 illustrates another example of source beam definition according to an embodiment of the present disclosure;

FIG. 8 illustrates another example of source beam definition according to an embodiment of the present disclosure;

FIG. 9 illustrates another example of source beam definition according to an embodiment of the present disclosure;

FIG. 10 illustrates an example of target beam generation according to an embodiment of the present disclosure;

FIG. 11 illustrates an example of a method for determining the application time of a first spatial filter used by a repeater for forwarding according to an embodiment of the present disclosure;

FIG. 12 illustrates another example of a method for determining the application time of the first spatial filter used by the repeater for forwarding according to the embodiment of the present disclosure;

FIG. 13 illustrates another example of target beam generation according to an embodiment of the present disclosure;

FIG. 14 illustrates a flowchart of a method performed by a repeater according to an embodiment of the present disclosure;

FIG. 15 illustrates a flowchart of a method performed by a repeater according to an embodiment of the present disclosure;

FIG. 16 illustrates a flowchart of a method performed by a repeater according to an embodiment of the present disclosure; and

FIG. 17 illustrates a block diagram of a repeater according to an embodiment of the present disclosure.

FIG. 18 illustrates the configuration of a UE or a repeater in a wireless communication system according to various embodiments.

FIG. 19 illustrates the configuration of a base station or a network entity in a wireless communication system according to various embodiments.

### BEST MODE FOR CARRYING OUT THE INVENTION

In an aspect of the present disclosure, a method performed by a repeater in a wireless communication network is provided, the method comprising: receiving reference signal information from a base station; and receiving and/or forwarding signal in time domain resources related to at least one of reference signals, wherein at least one of the reference signals is related to the reference signal information.

In an embodiment, the method further includes determining that at least one of the reference signals corresponds to the same quasi-co-location QCL assumption.

In an embodiment, receiving and/or forwarding signal in time domain resources related to at least one of reference signals includes receiving signal in time domain resources related to at least one of the reference signals using the same spatial filter.

In an embodiment, receiving and/or forwarding signal in time domain resources related to at least one of reference signals includes forwarding signal in time domain resources related to at least one of the reference signals using different spatial filters.

In an embodiment, the number of the reference signals is less than or equal to the maximum number of reference signals for forwarding supported by the repeater.

In an embodiment, at least one of the reference signals is received using the same spatial filter.

In another aspect of the present disclosure, a method performed by a repeater in a wireless communication network is provided, the method comprising: receiving time domain resource information from a base station; and receiving and/or forwarding signal in at least one of time domain resources, wherein at least one of the time domain resources is related to the time domain resource information.

In an embodiment, the method further comprises determining that at least one of the time domain resources corresponds to the same spatial filter.

In an embodiment, receiving and/or forwarding signal in at least one of time domain resources includes receiving and/or forwarding signal in at least one of the time domain resources using the same spatial filter.

In an embodiment, receiving and/or forwarding signal in at least one of time domain resources includes receiving and/or forwarding signal in at least one of the time domain resources using different spatial filters.

In another aspect of the present disclosure, a method performed by a repeater in a wireless communication network is provided, the method comprising: receiving and/or forwarding signal using a first spatial filter; wherein the first spatial filter is related to a second spatial filter; and the second spatial filter is related to at least one of the followings: a synchronization signal block (SSB); a channel state information reference signal (CSI-RS); a sounding reference signal (SRS); a transmission configuration indicator (TCI) state; spatial relation; time domain resource; and beam information.

In an embodiment, the repeater supports beam correspondence.

In another aspect of the present disclosure, a repeater is provided, including a mobile terminal configured to receive reference signal information from a base station; and a forwarding unit configured to receive and/or forward signal in time domain resources related to at least one of reference signals, wherein at least one of the reference signals is related to the reference signal information.

In another aspect of the present disclosure, a repeater is provided, including a mobile terminal configured to receive time domain resource information from a base station; and a forwarding unit configured to receive and/or forward signal in at least one of time domain resources, wherein at least one of the time domain resources is related to the time domain resource information.

In another aspect of the present disclosure, a repeater is provided, including a mobile terminal; and a forwarding unit configured to receive and/or forward signal using a first spatial filter; wherein the first spatial filter is related to a second spatial filter; and the second spatial filter is related to at least one of the following: a synchronization signal block (SSB); a channel state information reference signal (CSI-RS); a sounding reference signal (SRS); a transmission configuration indicator (TCI) state; spatial relation; time domain resource; and beam information.

In another aspect of the present disclosure, a method performed by a base station in a wireless communication network is provided, the method comprising: transmitting reference signal information to a repeater; wherein the reference signal information is used for the repeater to receive and/or forward signal in time domain resource related to at least one of reference signals, and at least one of the reference signals is related to the reference signal information.

In another aspect of the present disclosure, a method performed by a base station in a wireless communication network is provided, the method comprising: transmitting time domain resource information to a repeater; wherein the time domain resource information is used for the repeater to receive and/or forward signal in at least one of time domain resources, and at least one of the time domain resources is related to the time domain resource information.

### Mode for the Invention

To meet the demand for wireless data traffic having increased since deployment of 4th Generation (4G) or Long Term Evolution (LTE) communication systems and to enable various vertical applications, efforts have been made to develop and deploy an improved 5th Generation (5G) and/or New Radio (NR) or pre-5G/NR communication system. Therefore, the 5G/NR or pre-5G/NR communication system is also called a “beyond 4G network” or a “post LTE system.” The 5G/NR communication system is considered to be implemented in higher frequency (mmWave) bands, e.g., 28 giga-Hertz (GHz) or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and technologies associated therewith is for reference as certain embodiments of the present disclosure may be implemented in 5G systems, 6th Generation (6G) systems, or even later releases which may use terahertz (THz) bands. However, the present disclosure is not limited to any particular class of systems or the frequency bands associated therewith, and embodiments of the present disclosure may be utilized in connection with any frequency band. For example, aspects of the present disclosure may also be applied to deployment of 5G communication systems, 6G communications systems, or communications using THz bands.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

Hereinafter, embodiments of the present disclosure will be described in detail with reference to the accompanying drawings. It should be noted that in the drawings, the same or similar elements are denoted by the same or similar reference numerals as much as possible. In addition, detailed descriptions of known functions or configurations that may obscure the subject matter of the present disclosure will be omitted.

When describing the embodiments of the present disclosure, the description related to the technical contents known in the art and not directly related to the present disclosure will be omitted. Such unnecessary descriptions are omitted to prevent obscuring the main idea of this disclosure and to convey the main idea more clearly.

For the same reason, some elements may be enlarged, omitted or illustrated schematically in the drawings. In addition, the size of each component does not fully reflect the actual size. In the drawings, the same or corresponding elements have the same reference numerals.

The advantages and features of the present disclosure and the methods to implement them will become clear by referring to the embodiments described in detail below in conjunction with the accompanying drawings. However, the present disclosure is not limited to the embodiments set forth below, but can be implemented in various forms. The following examples are provided only to fully disclose this disclosure and inform those skilled in the art of the scope of this disclosure, and this disclosure is only limited by the scope of the appended claims. Throughout the specification, the same or similar reference numerals refer to the same or similar elements.

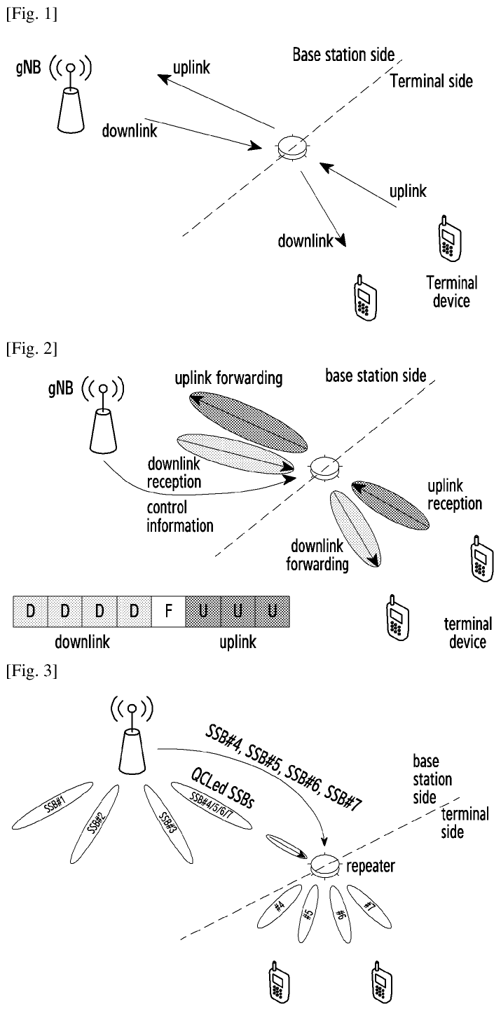

In order to enhance the coverage of the 5G wireless communication system, one implementation is to set up a repeater at the edge of the cell (or in other words, in the area with poor cell coverage). Generally, the repeater is usually divided into two sides, the base station side and the terminal side. FIG. 1 illustrates the structure of a 5G wirelesscommunication system including a repeater. As illustrated in FIG. 1, for the downlink of the base station, the repeater receives a radio frequency (RF) signal from the base station at the base station side. The RF signal passes through a built-in amplifier in the repeater, and the amplified signal is sent to the terminal device at the terminal side of the repeater. For the uplink of the base station, the repeater receives the radio frequency (RF) signal from the terminal device at the terminal side. The RF signal passes through the built-in amplifier in the repeater, and the amplified signal is sent to the terminal device at the base station side of the repeater.

Generally, the existing repeater cannot be controlled by the base station. That is, the existing repeater can only be manually adjusted for the reception and transmission direction of the repeater, which is not conducive to the flexibility of network deployment. In addition, the existing repeater cannot determine the time of uplink forwarding or downlink forwarding through the indication of the base station, which is not conducive to the deployment of a repeater in a TDD system. In order to solve the above problems, this disclosure proposes a series of methods, as illustrated in FIG. 2, to enable the repeater to receive the indication information from the network, so as to flexibly adjust the direction of signal reception and forwarding and the time of uplink forwarding/downlink forwarding, thereby improving the coverage and deployment flexibility of the wireless communication system.

In this disclosure, the repeater has two functions: one is to receive and forward radio frequency signal, and the other is to receive control information from the base station. Wherein, the module that receives and forwards the radio frequency signal can be called the network-controlled repeater RF forwarding unit (NCR-Forward) of the repeater, or the repeater forwarding unit, taking NCR-Forward as an example; in addition, the module for receiving control information from the base station is called network-controlled repeater mobile terminal (NCR-MT), or repeater mobile terminal, taking NCR-MT as an example. In this disclosure, the repeater can be interpreted as either the NCR-MT or the NCR-Forward, or the combination of both. In addition, the NCR-MT can also be equivalently understood as a UE, that is, it can be equivalently understood as a terminal device (UE).

In this disclosure, in order to avoid ambiguity, corresponding terms are defined here for the transmitting and receiving behaviors of a repeater. As illustrated in FIG. 2, for a repeater (especially an NCR-Forward), the reception of the downlink radio frequency signal (or the reception of the radio frequency signal at the base station side) is called downlink reception; transmitting the downlink radio frequency signal (in other words, transmitting the radio frequency signal at the terminal side; or, forwarding the radio frequency signal to the terminal) is called downlink forwarding; the reception of the uplink radio frequency signal (or the reception of the radio frequency signal at the terminal side) is called uplink reception; transmitting the uplink radio frequency signal (in other words, transmitting the radio frequency signal at the base station side; or forwarding the radio frequency signal to the base station) is called uplink forwarding.

In this disclosure, “receiving” can include uplink receiving and/or downlink receiving, and “forwarding” includes uplink forwarding and/or downlink forwarding.

The definition of source beam according to the embodiment of the present disclosure will be further explained below with reference to the drawings.

In an embodiment, the repeater receives reference signal information from a network device (e.g., a base station), which can be understood as the NCR-MT receiving an indication about a reference signal from the base station; the indication of the reference signal may be an indication of SSB, an indication of CSI-RS, an indication of SRS, or a combination thereof. In addition, it is further understood that the above reference signal information is used to indicate the QCL relation (or spatial relation; or, QCL information) of the reference signal.

FIG. 3 illustrates an example of source beam definition according to an embodiment of the present disclosure. As illustrated in FIG. 3, by receiving the system information, the repeater (NCR-MT) acquires the knowledge that in a cell, the base station transmits 8 SSBs, namely SSB #0 to SSB #7. Here, the repeater also receives reference signal information (for example, UE-specific information) from the base station, which explicitly indicates SSB indexes, such as SSB #4, SSB #5, SSB #6 and SSB #7.

It is further understood that the PRACH occasions corresponding to these SSBs are time division multiplexed (TDMed); or, these PRACH occasions do not overlap in time domain; or, these PRACH occasions are on different time domain resources (for example, different symbols/slots/subframes). The reason is that when the repeater is performing uplink/downlink reception/forwarding, considering from the perspective of hardware design, only one spatial/spatial domain filter can be used at the same time. Generally, in PRACH occasions corresponding to different SSBs, the repeater uses different spatial filters for uplink reception. Therefore, in order to avoid the spatial collision of PRACH occasions corresponding to different SSBs, the base station needs to ensure that the above indicated SSBs (for example, SSB #4, SSB #5, SSB #6, SSB #7) satisfy certain restrictions: PRACH occasions corresponding to these indicated SSBs do not overlap in time domain. Or, the PRACH occasions corresponding to these indicated SSBs are on non-overlapping time domain resources (for example, in different slots).

It is further understood that the time domain resources corresponding to these SSBs are TDMed; or, the time domain resources corresponding to these SSBs do not overlap; or, the time domain resources corresponding to SSBs are in different slots/subframes/system frames. The reason is that when the repeater is performing uplink/downlink reception/forwarding, considering from the perspective of hardware design, the beam switching cannot be too frequent, and only one spatial/spatial domain filter can be used in the same time unit. Generally, on the time domain resources corresponding to different SSBs, the repeater uses different spatial filters for downlink forwarding. Therefore, in order to avoid the beam collision caused by the indicated SSBs being in the same time unit, the base station needs to ensure that the indicated SSBs (for example, SSB #4, SSB #5, SSB #6, SSB #7) satisfy certain restrictions: the time domain resources corresponding to these indicated SSBs do not overlap. Or, the time domain resources corresponding to these indicated SSBs are in different time units (slots/subframes/system frames). For example, SSB #4 is in slot #1, SSB #5 is in slot #2, SSB #6 is in slot #3, and SSB #7 is in slot #4. After the NCR-MT receives the reference signal information, at least one of the following methods can be performed.

### Method 1

The repeater determines that one or more reference signals correspond to the same QCL assumption; wherein the one or more reference signals are related to the reference signal information. It can be understood that the repeater determining that one or more reference signals correspond to the same QCL assumption described herein can be understood as the repeater assuming that one or more reference signals correspond to the same QCL assumption. In this disclosure, QCL assumption can also be equivalently understood as QCL property, QCL parameters, or QCL type parameters.

The repeater determines that SSB #4, SSB #5, SSB #6 and SSB #7 correspond to the same beam (transmitted by the base station); or, the repeater determines that SSB #4, SSB #5, SSB #6 and SSB #7 correspond to the same downlink spatial transmission filter; or, the repeater determines that SSB #4, SSB #5, SSB #6 and SSB #7 correspond to the same QCL assumption; or, the repeater determines that SSB #4, SSB #5, SSB #6 and SSB #7 are QCLed; or, the repeater determines that SSB #4, SSB #5, SSB #6 and SSB #7 correspond to the same type-D QCL assumption.

The benefit of the above method 1 is: the repeater can forward corresponding SSBs using different spatial directions according to the reference signal information, so as to perform beam sweeping at its terminal side. This makes the terminal devices in different directions have the opportunities to (monitor the SSB) for initial access.

### Method 2

The repeater uses the same spatial filter to receive signal in time domain resources related to one or more reference signals; wherein the one or more reference signals are related to the reference signal information.

The repeater uses the same spatial filter to receive signal on the time domain resources related to SSB #4, SSB #5, SSB #6 and SSB #7.

One way to understand is that time domain resources related to one or more reference signals refer to symbols related to one or more reference signals. For example, the NCR-Forward uses the same spatial filter for downlink reception on the symbols where SSB #4, SSB #5, SSB #6 and SSB #7 are located.

Another way to understand is that time domain resources related to one or more reference signals refer to slots related to one or more reference signals. Here, the repeater can obtain the time domain information corresponding to corresponding SSBs by reading the system information. One possible situation is that SSB #4, SSB #5, SSB #6 and SSB #7 are in different slots, and the NCR-Forward uses the same spatial filter to perform downlink reception in the slots where SSB #4, SSB #5, SSB #6 and SSB #7 are located.

Another way to understand is that the time domain resources related to one or more reference signals correspond to the same periodicity. Here, the repeater can obtain the time domain information corresponding to corresponding SSBs by reading the system information. For example, in a cell, the system information indicates that the periodicity of an SSB is 80 ms. During this periodicity, SSB #4, SSB #5, SSB #6 and SSB #7 are respectively transmitted once, corresponding to four time domain resources, respectively. The NCR-Forward uses the same spatial filter for downlink reception on the four time domain resources.

The benefit of the above method 2 is: according to the reference signal information mentioned above, the repeater uses the same spatial direction to receive the radio frequency signal for the corresponding SSBs, so as to ensure that the received SSB energy (the energy entering the forwarding unit) is the same, and further, the transmission power of the SSBs is the same in the corresponding terminal side beam sweeping under the condition that the forwarding unit gain is fixed.

### Method 3

The repeater uses different spatial filters to forward signal in time domain resources related to one or more reference signals; wherein the one or more reference signals are related to the reference signal information.

The repeater uses different spatial filters to forward signal on the time domain resources related to SSB #4, SSB #5, SSB #6 and SSB #7, respectively.

One way to understand is that time domain resources related to one or more reference signals refer to symbols related to one or more reference signals. For example, the NCR-Forward uses different spatial filters to perform downlink forwarding on the symbols where SSB #4, SSB #5, SSB #6 and SSB #7 are located, respectively.

Another way to understand is that time domain resources related to one or more reference signals refer to slots related to one or more reference signals. That is, SSB #4, SSB #5, SSB #6 and SSB #7 are in different slots, and the NCR-Forward uses different spatial filters to perform downlink forwarding in the slots where SSB #4, SSB #5, SSB #6 and SSB #7 are located, respectively.

Another way to understand is that the time domain resources related to one or more reference signals correspond to the same SSB periodicity. For example, in a cell, the system information indicates that the periodicity of an SSB is 80 ms. During this periodicity, SSB #4, SSB #5, SSB #6 and SSB #7 are respectively transmitted once, corresponding to four time domain resources, respectively. The NCR-Forward uses different spatial filters for downlink forwarding on the four time domain resources.

The benefit of the above method 3 is: according to the reference signal information mentioned above, the repeater forwards the corresponding SSBs using different spatial directions, so as to ensure that the transmitted SSBs can use different beam directions for beam sweeping, and then the terminal devices in different positions can have the opportunities to receive an SSB.

### Method 4

The repeater receives and forwards signal in time domain resources related to one or more reference signals; wherein the one or more reference signals are related to the reference signal information.

The repeater receives and forwards signal on the time domain resources related to SSB #4, SSB #5, SSB #6 and SSB #7.

One way to understand is that time domain resources related to one or more reference signals refer to symbols related to one or more reference signals. For example, the NCR-Forward performs downlink reception and downlink forwarding on the symbols where SSB #4, SSB #5, SSB #6 and SSB #7 are located, respectively.

Another way to understand is that time domain resources related to one or more reference signals refer to slots related to one or more reference signals. That is, SSB #4, SSB #5, SSB #6 and SSB #7 are in different slots, and the NCR-Forward performs downlink receiving and downlink forwarding in the slots where SSB #4, SSB #5, SSB #6 and SSB #7 are located, respectively.

Another way to understand is that the time domain resources related to one or more reference signals correspond to the same SSB periodicity. For example, in a cell, the system information indicates that the periodicity of an SSB is 80 ms. During this periodicity, SSB #4, SSB #5, SSB #6 and SSB #7 are respectively transmitted once, corresponding to four time domain resources. The NCR-Forward performs downlink reception and downlink forwarding on the four time domain resources respectively.

The benefit of the above method 4 is: through the above method, the repeater can determine the time of downlink reception and downlink forwarding by receiving the reference signal information, and this method can flexibly indicate the time of downlink reception and downlink forwarding by using the related information of the indicated reference signal(s), thus improving the flexibility of the system.

In an embodiment, the number of one or more reference signals is less than or equal to the maximum number of reference signals for forwarding reported by the repeater.

For the repeater, it reports its corresponding capability (or terminal capability, UE capability) when accessing the network. The specific report content includes: the maximum number of different downlink transmitting beams supported by the repeater; or, the maximum number of different downlink forwarding beams supported by the repeater; or, the maximum number of forwarding reference signals supported by the repeater; or, the maximum number of forwarding reference signals (for beam sweeping) supported by the repeater. In the above example, the number of SSBs determined by the terminal device (namely SSB #4, SSB #5, SSB #6 and SSB #7, the number is 4) needs to be less than or equal to the reported number (the maximum number of different downlink transmitting beams). With this restriction, the base station can ensure that the number of indicated reference signals does not exceed the repeater's forwarding capability (beam sweeping capability).

In an embodiment, the repeater uses the same spatial filter to receive one or more reference signals.

For the repeater, it is possible that the NCR-MT and the NCR-Forward of the repeater share the same RF component; furthermore, the NCR-MT and the NCRForward can receive signals simultaneously. This means that the description of the NCR-Forward in the above method 2 is also applicable to the NCR-MT. On the other hand, in the above example (method 2), the NCR-MT uses the same spatial filter to receive SSB #4, SSB #5, SSB #6 and SSB #7.

In addition, for the method described above, the repeater can also be related to SSB #4. Or, the NCR-MT establishes a connection with the base station, and the last PRACH transmission of the NCR-MT is related to SSB #4. Or, the NCR-MT is associated with SSB #4 according to the indication of the base station. For example, the NCR-MT determines the TCI state of CORESET #0 according to the MAC CE indication; the TCI state includes a CSI-RS, which is QCLed with SSB #4; that is, the NCR-MT is associated with SSB #4. Because NCR-MT needs to monitor SSB #4, the repeater can perform the above operation when it supports the capability of simultaneously performing signal reception by the NCR-MT and downlink signal forwarding by the NCR-Forward (receiving the radio frequency signal from the base station side, amplifying it and transmitting it at the terminal side). Otherwise, if the repeater does not support the capability of simultaneously performing signal reception by the NCR-MT and downlink signal forwarding by the NCR-Forward, the NCRForward cannot forward the NCR-MT-related SSB (SSB #4), that is, this situation docs not consider the NCR-MT-related SSB (SSB #4). That is, only SSBs (SSB #5, SSB #6 and SSB #7) indicated by the reference signal information are considered in the above method description, that is, the descriptions of SSB #4, SSB #5, SSB #6 and SSB #7 are replaced with those of SSB #5, SSB #6 and SSB #7.

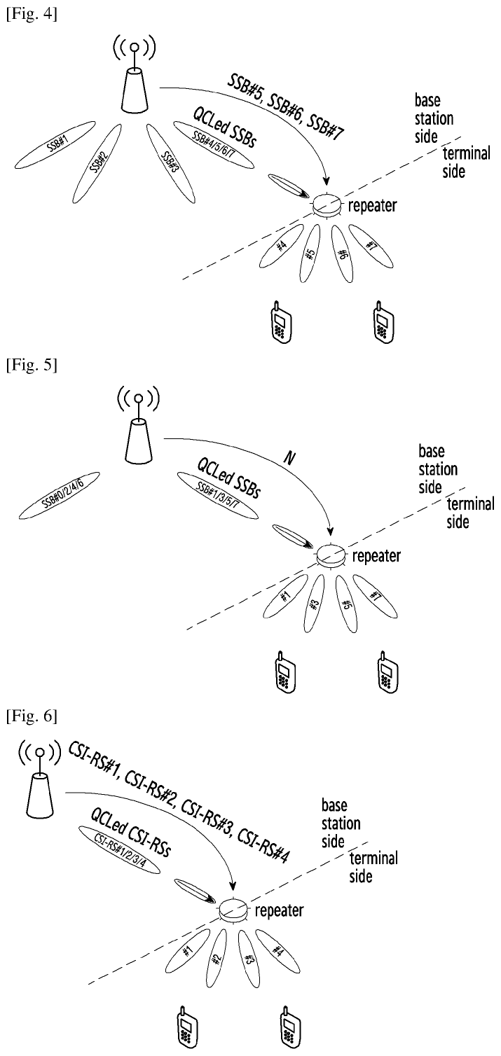

FIG. 4 illustrates another example of source beam definition according to an embodiment of the present disclosure. As illustrated in FIG. 4, by receiving the system information, the repeater (NCR-MT) knows that in a cell, the base station transmits 8 SSBs, namely SSB #0 to SSB #7. Here, the repeater also receives reference signal information (for example, UE-specific information) from the base station, which explicitly indicates SSB indexes, such as SSB #5, SSB #6, and SSB #7. In addition, the repeater is also related to SSB #4. Or, the NCR-MT establishes a connection with the base station, and the last PRACH transmission of the NCR-MT is related to SSB #4. Or, the NCR-MT is associated with SSB #4 according to the indication of the base station. For example, the NCR-MT determines the TCI state of CORESET #0 according to the MAC CE indication; the TCI state includes a CSI-RS, which is QCLed with SSB #4; that is, the NCR-MT is associated with SSB #4.

It is further understood that the PRACH occasions corresponding to the above SSBs (including SSBs indicated by the reference signal information and SSBs associated with the repeater, namely SSB #4, SSB #5, SSB #6, and SSB #7) are TDMed. In another case, the time domain resources corresponding to these SSBs are TDMed (time units are different). Specific description and reasons are based on the description of FIG. 3 above, which will not be repeated here.

After the NCR-MT receives the reference signal information, the method performed for SSB #4, SSB #5, SSB #6 and SSB #7 is the same as the embodiment illustrated in FIG. 3. Besides, in the methods 1 and 2 described in FIG. 3, optionally, the beams (QCL assumption, reception spatial filter, downlink spatial transmission filter) corresponding to SSB #5, SSB #6 and SSB #7 is determined according to the beam (QCL assumption, reception spatial filter, downlink spatial transmission filter) of SSB #4.

In addition, for the method described in FIG. 4, since the NCR-MT needs to monitor SSB #4, the above operation can only be performed when the repeater supports the capability of simultaneously performing signal reception by the NCR-MT and downlink signal forwarding by the NCR-Forward (receiving the radio frequency signal from the base station side, amplifying it and transmitting it at the terminal side). Otherwise, if the repeater does not support the capability of simultaneously performing signal reception by the NCR-MT and downlink signal forwarding by the NCR-Forward, the NCR-Forward cannot forward the NCR-MT-related SSB (SSB #4), that is, this situation does not consider the NCR-MT-related SSB (SSB #4). That is, in the method description of FIG. 4, only SSBs (SSB #5, SSB #6 and SSB #7) indicated by the reference signal information are considered, that is, the descriptions of SSB #4, SSB #5, SSB #6 and SSB #7 are replaced with those of SSB #5, SSB #6 and SSB #7.

The benefit of the method illustrated in FIG. 4 is: the above method enables the repeater to determine the SSB required for forwarding according to the reference signal information of the base station, the related SSB and its own capabilities. Compared with direct SSB indication, this method can save signaling overhead.

FIG. 5 illustrates another example of source beam definition according to an embodiment of the present disclosure. As illustrated in FIG. 5, by receiving the system information, the repeater (NCR-MT) knows that in a cell, the base station transmits 8 SSBs, namely SSB #0 to SSB #7. In addition, the repeater (NCR-MT) receives the reference signal information indicating a parameter N (N is a positive integer). Herein, the NCR-MT determines the QCL relation of SSBs according to the parameter N and SSB candidate ID. In addition, the repeater is also related to SSB #1. Or, the NCR-MT establishes a connection with the base station, and the last PRACH transmission of the NCR-MT is related to SSB #1. Or, the NCR-MT is associated with SSB #1 according to the indication of the base station. For example, the NCR-MT determines the TCI state of CORESET #0 according to the MAC CE indication; the TCI state includes a CSI-RS, which is QCLed with SSB #1; that is, the NCR-MT is associated with SSB #1.

Particularly, after the NCR-MT receives the parameter N, the repeater determines that SSBs with SSB ID i mod N are QCLed (i refers to SSB candidate ID). When N=2, for SSB #1, 1 mod 2=1. In addition, SSB #3, SSB #5 and SSB #7 have the same residue as SSB #1, namely 3 mod 2=1, 5 mod 2=1, 7 mod 2 =1, so the repeater determines SSB #1, SSB #3, SSB #5 and SSB #7 are associated (QCLed). For SSB #1, SSB #3, SSB #5 and SSB #7, the method performed is the same as that illustrated in FIG. 3.

In addition, for the method described in FIG. 5, since the NCR-MT needs to monitor SSB #1, the above operation can only be performed when the repeater supports the capability of simultaneously performing signal reception by the NCR-MT and downlink signal forwarding by the NCR-Forward (receiving the radio frequency signal from the base station side, amplifying it and transmitting it at the terminal side). Otherwise, if the repeater does not support the capability of simultaneously performing signal reception by the NCR-MT and downlink signal forwarding by the NCR-Forward, the NCR-Forward cannot forward the NCR-MT-related SSB (SSB #1), that is, this situation does not consider the NCR-MT-related SSB (SSB #1). That is, in the method description of FIG. 5, only SSBs (SSB #3, SSB #5 and SSB #7) that the NCR-MT does not need to monitor are considered, that is, the descriptions of SSB #1, SSB #3, SSB #5 and SSB #7 are replaced with those of SSB #3, SSB #5 and SSB #7.

The benefit of the method illustrated in FIG. 5 is: the above method enables the repeater to determine the SSB required for forwarding according to the reference signal information of the base station, the related SSB and its own capabilities. Compared with direct SSB indication, this method can save signaling overhead.

FIG. 6 illustrates another example of source beam definition according to an embodiment of the present disclosure. As illustrated in FIG. 6, the repeater receives reference signal information (e.g., UE-specific information) from the base station, which explicitly indicates a CSI-RS index (NZP-CSI-RS-ResourceId), for example, CSI-RS #1, CSI-RS #2, CSI-RS #3 and CSI-RS #4.

After the NCR-MT receives the reference signal information, at least one of the following methods can be performed.

### Method 1

The repeater determines that one or more reference signals correspond to the same QCL assumption; wherein the one or more reference signals are related to the reference signal information.

The repeater determines that CSI-RS #1, CSI-RS #2, CSI-RS #3 and CSI-RS #4 correspond to the same beam; or, the repeater determines that CSI-RS #1, CSI-RS #2, CSI-RS #3 and CSI-RS #4 correspond to the same downlink spatial transmission filter; or, the repeater determines that CSI-RS #1, CSI-RS #2, CSI-RS #3 and CSI-RS #4 correspond to the same QCL assumption; or, the repeater determines that CSI-RS #1, CSI-RS #2, CSI-RS #3 and CSI-RS #4 are QCLed; or, the repeater determines that CSI-RS #1, CSI-RS #2, CSI-RS #3 and CSI-RS #4 correspond to the same type-D QCL assumption.

On the other hand, the reference signals associated with the one or more reference signals (CSI-RS #1, CSI-RS #2, CSI-RS #3 and CSI-RS #4) are the same (the indication of qcl-InfoPeriodicCSI-RS is the same); or, TCI states associated with CSI-RS #1, CSI-RS #2, CSI-RS #3 and CSI-RS #4 are the same; or, CSI-RS #1, CSI-RS #2, CSI-RS #3 and CSI-RS #4 correspond to the same QCL source and QCL type; or, CSI-RS #1, CSI-RS #2, CSI-RS #3 and CSI-RS #4 are QCLed with the same SSB (for example, SSB #1). The SSB can also be an SSB associated with the repeater (NCR-MT). See the description of FIG. 3 for the detailed description of the SSB associated with the NCR-MT.

The benefit of the method 1 is: the repeater forwards the corresponding CSI-RSs using different spatial directions according to the reference signal information, so as to perform beam sweeping at its terminal side. This makes the terminal devices in different directions have the opportunities to (monitor CSI-RS) for channel measurement and corresponding data transmission.

### Method 2

The repeater uses the same spatial filter to receive signals in time domain resources related to one or more reference signals; wherein the one or more reference signals are related to the reference signal information.

The repeater uses the same spatial filter to receive signals on the time domain resources related to CSI-RS #1, CSI-RS #2, CSI-RS #3 and CSI-RS #4.

One way to understand is that time domain resources related to one or more reference signals refer to symbols related to one or more reference signals. Here, the repeater can obtain the time domain information corresponding to the corresponding CSI-RSs by reading the cell configuration information. For example, the NCR-Forward uses the same spatial filter for downlink reception on the symbols where CSI-RS #1, CSI-RS #2, CSI-RS #3 and CSI-RS #4 are located.

Another way to understand is that time domain resources related to one or more reference signals refer to slots related to one or more reference signals. Here, the repeater can obtain the time domain information corresponding to the corresponding CSI-RSs by reading the cell configuration information. One possible situation is that CSI-RS #1, CSI-RS #2, CSI-RS #3 and CSI-RS #4 are in different slots, and the NCR-Forward uses the same spatial filter for downlink reception in the slots where CSI-RS #1, CSI-RS #2, CSI-RS #3 and CSI-RS #4 are located.

Another way to understand is that the time domain resources related to one or more reference signals correspond to the same periodicity. For example, the indicated CSI-RSs (CSI-RS #1, CSI-RS #2, CSI-RS #3 and CSI-RS #4) correspond to the same periodicity. During a transmission periodicity, CSI-RS #1, CSI-RS #2, CSI-RS #3 and CSI-RS #4 are transmitted once, corresponding to four time domain resources respectively. The NCR-Forward uses the same spatial filter for downlink reception on these four time domain resources.

The benefit of the above method 2 is: according to the above-mentioned reference signal information, the repeater uses the same spatial direction to receive radio frequency signals for the corresponding CSI-RSs, so as to ensure that the received CSI-RS energy (the energy entering the forwarding unit) is the same, and the transmission power of CSI-RS is the same in the corresponding terminal side beam sweeping under the condition that the forwarding unit gain is fixed.

### Method 3

The repeater uses different spatial filters to forward signals in time domain resources related to one or more reference signals; wherein the one or more reference signals are related to the reference signal information.

The repeater uses different spatial filters to forward signals on the time domain resources related to CSI-RS #1, CSI-RS #2, CSI-RS #3 and CSI-RS #4.

One way to understand is that time domain resources related to one or more reference signals refer to symbols related to one or more reference signals. Here, the repeater can obtain the time domain information corresponding to the corresponding CSI-RSs by reading the cell configuration information. For example, the NCR-Forward uses different spatial filters to perform downlink forwarding on the symbols where CSI-RS #1, CSI-RS #2, CSI-RS #3 and CSI-RS #4 are located, respectively.

Another way to understand is that time domain resources related to one or more reference signals refer to slots related to one or more reference signals. Here, the repeater can obtain the time domain information corresponding to the corresponding CSI-RSs by reading the cell configuration information. One possible situation is that CSI-RS #1, CSI-RS #2, CSI-RS #3 and CSI-RS #4 are in different slots, and the NCR-Forward uses different spatial filters to perform downlink forwarding in the slots where CSI-RS #1, CSI-RS #2, CSI-RS #3 and CSI-RS #4 are located, respectively.

Another way to understand is that the time domain resources related to one or more reference signals correspond to the same periodicity. For example, the indicated CSI-RSs (CSI-RS #1, CSI-RS #2, CSI-RS #3 and CSI-RS #4) correspond to the same periodicity. During a transmission periodicity, CSI-RS #1, CSI-RS #2, CSI-RS #3 and CSI-RS #4 are transmitted once, corresponding to four time domain resources respectively. The NCR-Forward uses different spatial filters for downlink forwarding on these four time domain resources.

The benefit of the above method 3 is: according to the above-mentioned reference signal information, the repeater forwards the corresponding CSI-RSs using different spatial directions, so as to ensure that the transmitted CSI-RSs can use different beam directions for beam sweeping, and then the terminal devices in different positions can have the opportunities to receive a CSI-RS.

### Method 4

The repeater receives and forwards signals in time domain resources related to one or more reference signals; wherein the one or more reference signals are related to the reference signal information.

The repeater receives and forwards signals in time domain resources related to CSI-RS #1, CSI-RS #2, CSI-RS #3 and CSI-RS #4.

One way to understand is that time domain resources related to one or more reference signals refer to symbols related to one or more reference signals. Here, the repeater can obtain the time domain information corresponding to the corresponding CSI-RSs by reading the cell configuration information. For example, the NCR-Forward performs downlink reception and downlink forwarding on the symbols where CSI-RS #1, CSI-RS #2, CSI-RS #3 and CSI-RS #4 are located.

Another way to understand is that time domain resources related to one or more reference signals refer to slots related to one or more reference signals. Here, the repeater can obtain the time domain information corresponding to the corresponding CSI-RSs by reading the cell configuration information. A possible situation is that CSI-RS #1, CSI-RS #2, CSI-RS #3 and CSI-RS #4 are in different slots, and the NCR-Forward performs downlink reception and downlink forwarding in the slots where CSI-RS #1, CSI-RS #2, CSI-RS #3 and CSI-RS #4 are located.

Another way to understand is that the time domain resources related to one or more reference signals correspond to the same periodicity. For example, the indicated CSI-RSs (CSI-RS #1, CSI-RS #2, CSI-RS #3 and CSI-RS #4) correspond to the same periodicity. During a transmission periodicity, CSI-RS #1, CSI-RS #2, CSI-RS #3 and CSI-RS #4 are transmitted once, corresponding to four time domain resources respectively. The NCR-Forward performs downlink reception and downlink forwarding on these four time domain resources.

The benefit of the above method 4 is: through the above method, the repeater can determine the time of downlink reception and downlink forwarding by receiving the reference signal information, and this method can flexibly indicate the time of downlink reception and downlink forwarding by using the related information of the indicated reference signals, thus improving the flexibility of the system.

In an embodiment, the number of one or more reference signals is less than or equal to the maximum number of reference signals for forwarding reported by the repeater.

For the above repeater, it will report its corresponding capability (or terminal capability, UE capability) when accessing the network. The specific report content includes: the maximum number of different downlink transmitting beams supported by the repeater; or, the maximum number of different downlink forwarding beams supported by the repeater; or, the maximum number of forwarding reference signals supported by the repeater; or, the maximum number of forwarding reference signals (for beam sweeping) supported by the repeater. In the above example, the number of CSI-RS determined by the terminal device (i.c. CSI-RS #1, CSI-RS #2, CSI-RS #3 and CSI-RS #4, the number is 4) needs to be less than or equal to the reported number (the maximum number of different downlink transmitting beams). With this restriction, this method can make the base station ensure that the number of indicated reference signals does not exceed the forwarding capability (beam sweeping capability) of the repeater.

In an embodiment, the repeater uses the same spatial filter to receive one or more reference signals.

For the above repeater, optionally, the NCR-MT and the NCR-Forward of the repeater share the same RF components; furthermore, the NCR-MT and the NCRForward can receive signals simultaneously. That is, the description of the NCRForward in the method 2 above is also applicable to the NCR-MT. On the other hand, in the above example (method 2), the NCR-MT uses the same spatial filter to receive CSI-RS #1, CSI-RS #2, CSI-RS #3 and CSI-RS #4.

Furthermore, for the method described above, the repeater can also be related to CSI-RS #4. For example, the NCR-MT monitors, receives or measures CSI-RS #4 according to the indication of the base station. Therefore, when the repeater supports the capability of simultaneously performing signal reception by the NCR-MT and downlink signal forwarding by the NCR-Forward (receiving the radio frequency signals from the base station side, amplifying them and transmitting them at the terminal side), the above operation can be performed. Otherwise, if the repeater does not support the capability of simultaneously performing signal reception by the NCR-MT and downlink signal forwarding by the NCR-Forward, the NCR-Forward cannot forward the CSI-RS related to the NCR-MT (CSI-RS #4), that is, this situation does not consider the CSI-RS related to the NCR-MT (CSI-RS #4). That is, only the remaining CSI-RSs (CSI-RS #1, CSI-RS #2 and CSI-RS #3) are considered in the above method description, that is, the descriptions of CSI-RS #1, CSI-RS #2, CSI-RS #3 and CSI-RS #4 are replaced with CSI-RS #1, CSI-RS #2, and CSI-RS #3.

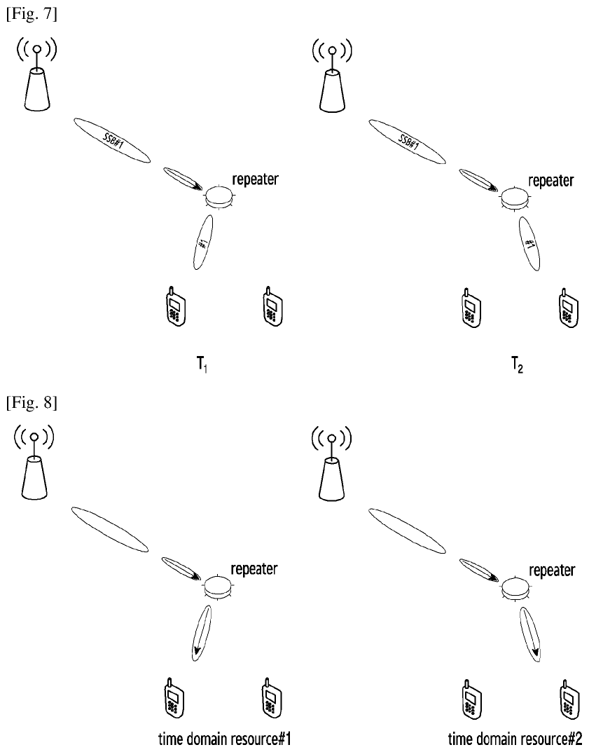

FIG. 7 illustrates another example of source beam definition according to an embodiment of the present disclosure. As illustrated in FIG. 7, the repeater is associated with an SSB. There are two methods to determine this SSB. One method is that a repeater receives reference signal information (for example, UE-specific information) from a base station, and the reference signal information explicitly indicates the SSB index, for example, SSB #1. Another method is that the repeater (NCR-MT) establishes a connection with the base station, and the last PRACH transmission of the NCR-MT is related to SSB #1. There is another method, associating with an SSB according to the indication of the base station. For example, the NCR-MT determines the TCI state of CORESET #0 according to the MAC CE indication; the TCI state includes a CSI-RS, which is QCLed with SSB #1; that is, the NCR-MT is associated with SSB #1.

After the repeater obtains the information of the associated SSB according to at least one of the above three methods, at least one of the following methods can be performed.

### Method 1

The repeater uses the same spatial filter to receive signal in time domain resources related to a reference signal; wherein the one reference signal is related to the reference signal information.

The repeater uses the same spatial filter to receive signal on multiple periodic time domain resources of SSB #1.

One way to understand is that the repeater uses the same spatial filter to receive signal in X periodicities of SSB #1 according to the indication of the base station, where X is a positive integer. For example, by reading the system information, the repeater can obtain the periodicity of an SSB is of 80 ms. When X=4, in the four periodicities corresponding to SSB #1, four transmissions corresponding to SSB #1 correspond to four time domain resources respectively. The NCR-Forward uses the same spatial filter for downlink reception on the four time domain resources.

The benefit of the above method 1 is: according to the above reference signal information, the repeater uses the same spatial direction to receive radio frequency signal in multiple periodicities of an SSB, so as to ensure that the received SSB energy (energy entering the forwarding unit) is the same, and the transmission power of the SSB is the same in the corresponding terminal side beam sweeping under the condition that the forwarding unit gain is fixed.

### Method 2

The repeater uses different spatial filters to forward signal in time domain resources related to a reference signal; wherein the one reference signal is related to the reference signal information.

The repeater uses different spatial filters to forward signal on multiple periodic time domain resources of SSB #1.

One way to understand is that the repeater uses different spatial filters to forward signal in X periodicities of SSB #1 according to the indication of the base station, where X is a positive integer. For example, by reading the system information, the repeater can obtain that the periodicity of an SSB is 80 ms. When X=4, in the four periodicities corresponding to SSB #1, four transmissions corresponding to SSB #1 correspond to four time domain resources respectively. The NCR-Forward uses different spatial filters for downlink forwarding on these four time domain resources.

The benefit of the above method 2 is: according to the above-mentioned reference signal information, the repeater forwards the radio frequency signal using different spatial directions for the corresponding reference signals, so as to ensure that the transmitted reference signals can use different beam directions for beam sweeping, so that the terminal devices in different positions can have the opportunities to receive the corresponding reference signal.

For the above repeater, it reports its corresponding capability (or terminal capability, UE capability) when accessing the network. The specific report content includes: the maximum number of different downlink transmitting beams (spatial filters) supported by the repeater; or, the maximum number of different downlink forwarding beams supported by the repeater; or, the maximum number of different downlink forwarding beams for beam sweeping supported by the repeater; or, the maximum number of forwarding reference signals (for beam sweeping) supported by the repeater. In the above example, the number (i.e. 4) of periodicities X determined by the terminal device needs to be less than or equal to the number of the maximum different downlink transmitting beams supported by the repeater. With this restriction, this method can make the base station ensure that the number of indicated reference signals does not exceed the forwarding capability (beam sweeping capability) of the repeater.

It should be noted that the above description only takes SSB as an example, and can also take other reference signals as an example, such as the CSI-RS, the PRS (positioning reference signal). This disclosure is not limited to this.

In an embodiment, the repeater receives time domain resource information from a network device, which can be understood as the NCR-MT receiving an indication about time domain resource information from a base station. In addition, it is further understood that the above time domain resource information indicates the spatial relation between time domain resources.

FIG. 8 illustrates another example of source beam definition according to an embodiment of the present disclosure. As illustrated in FIG. 8, the repeater receives time domain resource information (e.g., UE-specific information) from the base station, which indicates one or more time domain resources, for example, time domain resource #1 and time domain resource #2. Specifically, it can indicate the starting time, duration and periodicity of time domain resources. In addition, the following time-domain resource #1 and time-domain resource #2 can be further understood that they correspond to two time-domain resource indications, which have the same periodicity, and time-domain resource #1 and time-domain resource #2 are in the same periodicity.

After the NCR-MT receives the time domain resource information, at least one of the following methods can be performed.

### Method 1

The repeater determines that multiple time domain resources correspond to the same spatial filter; wherein the multiple time domain resources are related to the time domain resource information.

The repeater determines that time domain resource #1 and time domain resource #2 correspond to the same beam (transmitted by the base station); or, the repeater determines that the base station uses the same downlink spatial transmission filter to transmit signals in time domain resource #1 and time domain resource #2; the repeater determines that the base station uses the same spatial filter to transmit signals in time domain resource #1 and time domain resource #2.

The benefit of the above method 1 is: the repeater forwards the corresponding time domain resources in different spatial directions according to the time domain resource information, so as to perform the beam sweeping at its terminal side. This makes the terminal devices in different directions have the opportunities to detect the signal from the base station.

### Method 2

The repeater uses the same spatial filter to receive signals on multiple time domain resources; wherein the multiple time domain resources are related to the time domain resource information.

The repeater uses the same spatial filter to receive signal in time domain resource #1 and time domain resource #2. For example, the NCR-Forward uses the same spatial filter for downlink reception in time domain resource #1 and time domain resource #2.

The benefit of the above method 2 is: according to the above-mentioned reference signal information, the repeater uses the same spatial direction to receive radio frequency signal for the corresponding time domain resources, so as to ensure that the received energy (the energy entering the forwarding unit) is the same, and then the transmission power of the SSBs is the same in the corresponding terminal side beam sweeping under the condition that the forwarding unit gain is fixed.

Method 3:

The repeater uses different spatial filters to forward signal on multiple time domain resources; wherein the multiple time domain resources are related to the time domain resource information.

The repeater uses different spatial filters to forward signal in time domain resource #1 and time domain resource #2. For example, the NCR-Forward uses different spatial filters to perform downlink forwarding in time domain resource #1 and time domain resource #2 respectively.

The benefit of the above method 3 has the beneficial effects: according to the above-mentioned reference signal information, the repeater forwards radio frequency signal using different spatial directions for the corresponding time domain resources, so as to ensure that the repeater can use different beam directions for beam sweeping on these time domain resources and increase the coverage of the communication system.

Method 4:

The repeater receives and forwards signal on multiple time domain resources; wherein the multiple time domain resources are related to the time domain resource information.

The repeater receives and forwards signal in time domain resource #1 and time domain resource #2. For example, the NCR-Forward performs downlink reception and downlink forwarding in time domain resource #1 and time domain resource #2.

The benefit of the above method 4 is: through the above method, the repeater can determine the forwarding time of the downlink radio frequency signal by receiving the reference signal information, and this method can flexibly indicate the downlink receiving and forwarding time by using the related information of the indicated reference signals, thus improving the flexibility of the system.

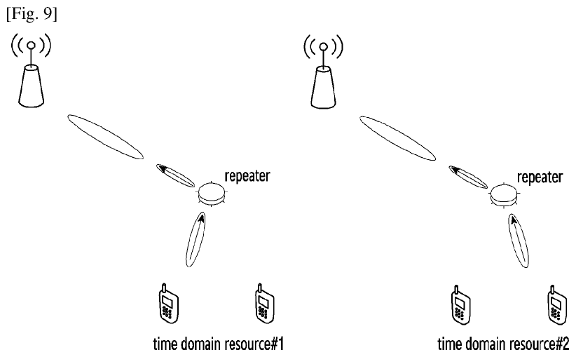

FIG. 9 illustrates another example of source beam definition according to an embodiment of the present disclosure. As illustrated in FIG. 9, the repeater receives time domain resource information (e.g., UE-specific information) from the base station, which indicates one or more time domain resources, for example, time domain resource #1 and time domain resource #2. Specifically, it can indicate the starting time, duration and periodicity of time domain resources. In addition, the following time-domain resource #1 and time-domain resource #2 can be further understood that they correspond to two time-domain resource indications, which have the same periodicity, and time-domain resource #1 and time-domain resource #2 are in the same periodicity.

After the NCR-MT receives the time domain resource information, at least one of the following methods can be performed.

### Method 1

The repeater uses the same spatial filter to forward signals on multiple time domain resources; wherein the multiple time domain resources are related to the time domain resource information.

The repeater uses the same spatial filter to forward signal in time domain resource #1 and time domain resource #2. For example, the NCR-Forward uses the same spatial filter for uplink forwarding in time domain resource #1 and time domain resource #2.

The benefit of the above method 1 is: the repeater uses the same spatial direction for uplink forwarding for the corresponding time domain resources according to the time domain resource information, so as to ensure the paths from the repeater to the base station are the same. This can support the receiving beam sweeping at the terminal side and improve the coverage of the system.

### Method 2

The repeater uses different spatial filters to receive signal on multiple time domain resources; wherein the multiple time domain resources are related to the time domain resource information.

The repeater uses different spatial filters to receive signal in time domain resource #1 and time domain resource #2. For example, the NCR-Forward uses different spatial filters to perform uplink reception in time domain resource #1 and time domain resource #2, respectively.

The benefit of the above method 2 is: according to the above-mentioned time domain resource information, the repeater forwards radio frequency signal using different spatial directions for the corresponding time domain resources, so as to ensure that the repeater can use different beam directions for beam sweeping on these time domain resources and increase the coverage of the communication system.

Method 3:

The repeater receives and forwards signal on multiple time domain resources; wherein the multiple time domain resources are related to the time domain resource information.

The repeater receives and forwards signal in time domain resource #1 and time domain resource #2. For example, the NCR-Forward performs uplink reception and uplink forwarding in time domain resource #1 and time domain resource #2.

The benefit of the above method 3 is: through the above method, the repeater can determine the time of uplink reception and uplink forwarding through the time domain resource information, and this method can flexibly indicate the time of downlink reception and downlink forwarding by using the related information of the indicated reference signals, thus improving the flexibility of the system.

Beam referencing according to an embodiment of the present disclosure will be further explained below with reference to the drawings.

Generally, the repeater needs to associate the source beam and the target beam for beam referencing. The source beam is generally determined by beam training and beam sweeping. A method of determining the source beam is based on the above description according to FIGS. 3 to 9. For example, SSB, CSI-RS, and time domain resources (or SSB ID, CSI-RS ID, and time domain resource ID) of the embodiments described in FIGS. 3 to 9 can be used as a source beam. Optionally, the beam information (beam ID), or the spatial filter corresponding to the beam information (beam ID) is used as the source beam. That is, the beam ID is associated with a spatial filter, and then the indication of the target beam is achieved by the beam ID; or, the beam ID is associated with a spatial filter, and then the base station indicates the repeater to use the corresponding spatial filter for downlink transmission or uplink reception according to the beam ID. The target beam refers to the beam that the repeater uses/applies to the corresponding time domain resource (or reference signal/channel) by receiving the indication information from the base station or in a predefined approach. By associating the target beam with the source beam, beam referencing can be achieved. Since both the source beam and the target beam are generated by the repeater, the beam referencing only needs to indicate the relationship between the source beam and the target beam, and avoids describing the parameters of the specific spatial filter corresponding to the source beam and the target beam. This has the advantage of virtualizing the beam, avoiding exposing the details of the hardware of the beam generation of the repeater, and at the same time making such beam referencing method more general (applicable to more hardware).

In the following embodiments, the source beam is called a second spatial filter; the target beam is called a first spatial filter.

Through the following specific examples, the association methods for the source beam and the target beam in downlink reception, downlink forwarding, uplink reception and uplink forwarding are described respectively.

In addition, it is noted that the source beam being associated with the target beam can be understood as the first spatial filter being related to the second spatial filter. The first spatial filter being related to the second spatial filter can be understood as the first spatial filter is the same as the second spatial filter. The first spatial filter being related to the second spatial filter can also be understood as the first spatial filter is obtained from the second spatial filter. The first spatial filter being obtained from the second spatial filter can be further understood as the parameters of the first spatial filter (for example, angle of arrival, angle of departure or beam width) being obtained from the parameters of the second spatial filter (for example, angle of arrival, angle of departure or beam width). In the following example, the first spatial filter being related to the second spatial filter takes the first spatial filter and the second spatial filter being the same as an example.

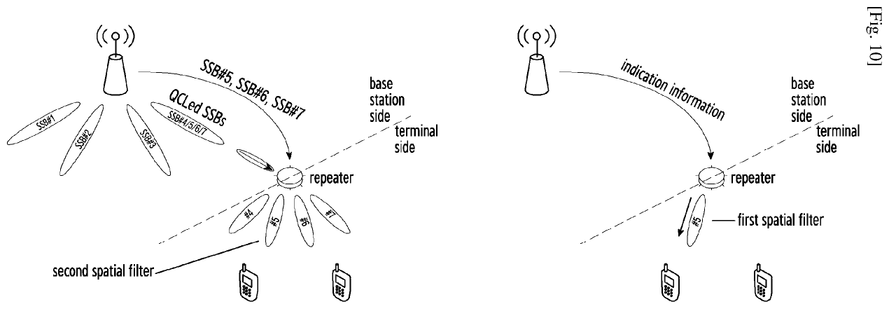

FIG. 10 illustrates an example of target beam generation according to an embodiment of the present disclosure.

The first spatial filter used by the repeater for downlink forwarding can be determined by the following methods.

### Method 1

The repeater determines the first spatial filter according to the received (spatial or beam) indication information. Or, the repeater uses the corresponding first spatial filter for downlink forwarding according to the indication information.

One case is that the indication information is reference signal information. Optionally, the reference signal information is related to a CSI-RS, an SSB or a PRS, such as CSI-RS ID, SSB ID or PRS ID. Take SSB ID as an example in the following description.

As illustrated in FIG. 10, referring to the methods provided in FIGS. 3 to 7, the repeater can implement the beam sweeping of an SSB by forwarding the SSB. According to this method, spatial filter #4, spatial filter #5, spatial filter #6 and spatial filter #7 are associated with SSB #4, SSB #5, SSB #6 and SSB #7, respectively. At this time, the repeater receives the reference signal indication (SSB #5) from the base station. After receiving this information, the repeater uses the first spatial filter (spatial filter #5) for downlink forwarding. Or, the first spatial filter used by the repeater for downlink forwarding is the same as the second spatial filter; the second spatial filter refers to the spatial filter related to the corresponding reference signal (SSB #5). Furthermore, the spatial filter related to the corresponding reference signal (SSB #5) refers to the spatial filter used by the repeater for downlink transmission on the time domain resources related to the corresponding reference signal (SSB #5). Furthermore, the time domain resource related to the corresponding reference signal (for example, SSB #5) refers to the last time domain resource related to the corresponding reference signal (SSB #5) (the time domain resource corresponding to the last SSB #5 transmission). For example, the second spatial filter refers to the downlink forwarding spatial filter used by the repeater for the last SSB (corresponding time domain resource) before using the first spatial filter.

Another case is that the indication information is TCI state information (TCI state ID). The TCI state information may be a downlink TCI state or a joint TCI state. According to the configuration information of the corresponding TCI state, the repeater can know the reference signal associated with the TCI state indicated in the indication information, and determine its associated (downlink) reference signal (SSB/CSI-RS). Then, according to the method described above, determine the filter used for downlink forwarding. For example, the indication information indicates TCI state #1, and its associated SSB is SSB #2. In this case, the repeater use the spatial filter related to SSB #2 for downlink forwarding according to the similar method described above.

Another case is that the indication information is time domain resource information (time domain resource ID), for example, the time domain resource (time domain resource #1) described in FIGS. 8 to 9. At this time, the repeater uses the first spatial filter for downlink forwarding. Or, the first spatial filter used by the repeater for downlink forwarding is the same as the second spatial filter; the second spatial filter refers to a spatial filter related to the time domain resource (time domain resource #1) corresponding to the time domain resource information. That is, the second spatial filter is a spatial filter used by the repeater for downlink forwarding on the time domain resource #1.

Another case is that the indication information is beam information (beam ID). One implementation method is that the beam ID is associated with the above-described reference signal (reference signal ID), TCI state (TCI state ID) and time domain resource (time domain resource ID). At this time, the repeater uses the first spatial filter for downlink forwarding. Or, the first spatial filter used by the repeater for downlink forwarding is the same as the second spatial filter; the second spatial filter refers to the spatial filter related to the beam information (reference signal, TCI state, time domain resources associated with the beam information).

### Method 2

The repeater determines the first spatial filter according to the signal/channel associated with the time domain resources for downlink forwarding. Or, the repeater performs downlink forwarding according to the first spatial filter corresponding to the signal/channel associated with the time domain resource for downlink forwarding.

One case is that the repeater performs downlink forwarding on the time domain resources related to a CORESET. At this time, the repeater determines the first spatial filter according to the reference signal (SSB) associated with the CORESET. Wherein, optionally the CORESET refer to CORESET #0 or a CORESET containing Type0-PDCCH CSS set. For example, the SSB associated with CORESET #0 is SSB #1. In this case, the repeater uses the spatial filter related to SSB #1 for downlink forwarding on the time domain resources related to CORESET #0 according to the method described above.

Another case is that the repeater performs downlink forwarding on the time domain resource related to PDSCH. At this time, the repeater determines the first spatial filter according to the reference signal (SSB) associated with the PDSCH. Optionally, PDSCH refers to the PDSCH related to system information. For example, the SSB associated with a PDSCH carrying system information is SSB #1. In this case, the repeater uses the spatial filter corresponding to SSB #1 for downlink forwarding on the time domain resources related to the PDSCH according to the method described above.

Another case is that the repeater performs downlink forwarding on the time domain resources related to a CSI-RS. At this time, the repeater determines the first spatial filter according to the reference signal (SSB) associated with the CSI-RS. Wherein, optionally the CSI-RS refers to the CSI-RS used for (time-frequency) tracking. For example, CSI-RS #1 and SSB #1 are QCLed. In this case, the repeater performs downlink forwarding on the time domain resources related to CSI-RS #1 by using the spatial filter corresponding to SSB #1 according to the method described above.

Optionally, the application time of the first spatial filter used by the repeater for downlink forwarding is determined by the following methods:

### Method 1

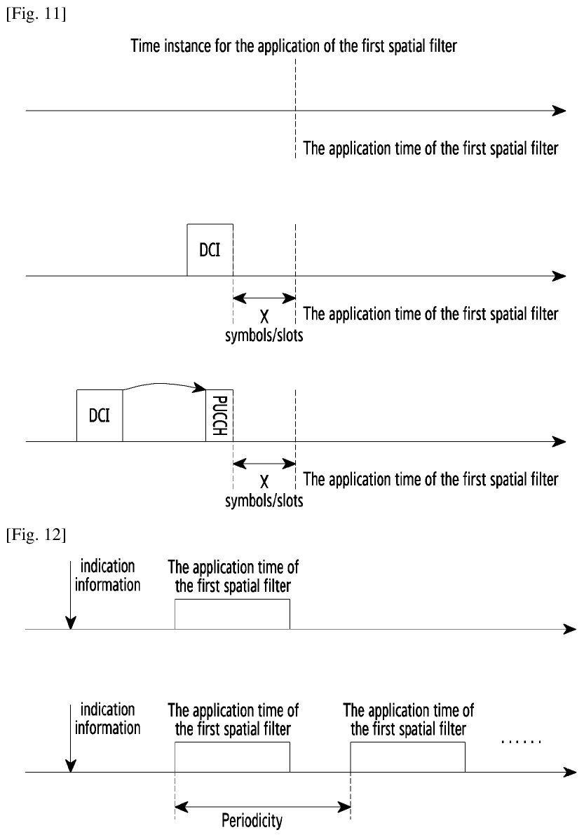

FIG. 11 illustrates an example of a method for determining the application time of the first spatial filter used by the repeater for forwarding according to an embodiment of the present disclosure. As illustrated in FIG. 11, the repeater determines the time instance for the application of the first spatial filter according to the received indication information. Or, the repeater (starts to) use(s) the first spatial filter for downlink transmission after the corresponding time instance according to the indication information. For example, the above indication information is DCI, which includes an indication of the first spatial filter of the repeater, and the time instance for the application of the indication is related to the DCI or the PUCCH carrying HARQ-ACK triggered by the DCI (for example, the time instance is after the DCI or the PUCCH; e.g., the time instance for the application of the first spatial filter is after X symbols/slots from the DCI or the PUCCH). In addition, DCI triggering a PUCCH means that DCI directly corresponds to the PUCCH, that is, the PUCCH contains HARQ-ACK feedback for the DCI; alternatively, DCI triggering a PUCCH means that DCI schedules a PDSCH, and the PDSCH corresponds to a PUCCH for carrying the HARQ-ACK feedback for the PDSCH.

### Method 2

FIG. 12 illustrates another example of a method for determining the application time of the first spatial filter used by the repeater for forwarding according to the embodiment of the present disclosure. As illustrated in FIG. 12, the repeater determines the application time of the first spatial filter according to the received indication information. Or, according to the indication information, the repeater uses the first spatial filter for downlink forwarding during the corresponding application time. For example, the indication information indicates the starting position and duration of time domain resource, and the repeater determines the time domain resources according to the information, and uses the first spatial filter on the time domain resources for downlink forwarding. For another example, the indication information indicates the starting position, duration and periodicity of time domain resource, and the repeater determines a set of time domain resources according to the information, and uses the first spatial filter in the set of time domain resources for downlink forwarding.

FIG. 13 illustrates another example of target beam generation according to the embodiment of the present disclosure. The first spatial filter used by the repeater for uplink reception can be determined by the following methods:

### Method 1

The repeater determines the first spatial filter according to the received (spatial or beam) indication information. Or, the repeater uses the corresponding first spatial filter for uplink reception according to the indication information.

One case is that the indication information is reference signal information. As illustrated in FIG. 13, the specific implementation is similar to that illustrated in FIG. 10. That is, the spatial filter used by the repeater for uplink reception is the same as the spatial filter used for downlink transmission. This exploits the reciprocity between uplink and downlink channels. It is further understood that a condition where this method can be used is that the repeater supports beam correspondence. The repeater supporting beam correspondence can be understood as the repeater supporting beam correspondence in FR2. Or, the repeater supporting beam correspondence can be understood as the repeater having the capability to select/determine the uplink receiving beam (spatial filter) according to the downlink transmitting beam (spatial filter). The reason why the repeater needs to support the beam correspondence is that only the repeater that supports the beam correspondence can perform beam referencing by using reciprocity.

Another case is that the indication information is TCI state information (TCI state ID). Optionally, the TCI state information is an uplink TCI state or a joint TCI state. As illustrated in FIG. 13, the specific implementation is similar to that illustrated in FIG. 10. That is, the spatial filter used by the repeater for uplink reception is the same as the spatial filter used for downlink transmission. This exploits the reciprocity between uplink and downlink channels. It is further understood that a condition that this method can be used is that the repeater supports beam correspondence. The repeater supporting beam correspondence can be understood as repeater supporting beam correspondence in FR2. Or, the repeater supporting beam correspondence can be understood as the repeater having the capability to select/determine the uplink receiving beam (spatial filter) according to the downlink transmitting beam (spatial filter). The reason why the repeater needs to support the beam correspondence is that only the repeater that supports the beam correspondence can perform beam referencing by using reciprocity.

Another case is that the indication information is time domain resource information (time domain resource ID), for example, the time domain resource (time domain resource #1) described in FIGS. 8-9. At this time, the repeater uses the first spatial filter for uplink reception. Or, the first spatial filter used by the repeater for uplink reception is the same as the second spatial filter; the second spatial filter refers to the spatial filter related to the corresponding time domain resource (time domain resource #1). That is, the second spatial filter is a spatial filter used by the repeater for downlink transmission (or uplink reception) in time domain resource #1. It is further understood that when the time domain resource information (time domain resource #1) corresponds to the downlink forwarding (or when it corresponds to the downlink forwarding spatial filter), a condition that this method can be used is that the repeater supports beam correspondence. The repeater supporting beam correspondence can be understood as repeater supporting beam correspondence in FR2. Or, the repeater supporting beam correspondence can be understood as the repeater having the capability to select/determine the uplink receiving beam (spatial filter) according to the downlink transmitting beam (spatial filter). The reason why the repeater needs to support the beam correspondence is that only the repeater that supports the beam correspondence can perform beam referencing by using reciprocity.

Another case is that the indication information is beam information (beam ID). One implementation method is that the beam ID is associated with the above-described reference signal (reference signal ID), TCI state (TCI state ID) or time domain resource (time domain resource ID). At this time, the repeater uses the first spatial filter for uplink reception. Or, the first spatial filter used by the repeater for uplink reception is the same as the second spatial filter; the second spatial filter refers to the (downlink forwarding) spatial filter related to the beam information (reference signal, TCI state, time domain resources associated with the beam information).

### Method 2

The repeater determines the first spatial filter according to the signal/channel associated with the time domain resource for uplink reception. Or, the repeater performs uplink reception according to the first spatial filter corresponding to the signal/channel associated with the time domain resource for uplink reception.

One case is that the repeater performs uplink reception on the time domain resources related to PRACH. The repeater obtains PRACH-related time domain resource information according to system information. Because there is a mapping relationship between PRACH resources and SSBs, the repeater can thus know the SSB associated with the PRACH. Therefore, the repeater performs uplink reception on the time domain resources related to the PRACH according to the spatial filter corresponding to the SSB related to the PRACH resources. It should be noted that the PRACH resources corresponding to SSBs forwarded by the repeater are time-division multiplexed (do not overlap in time domain) because the repeater generally cannot use multiple different spatial filters for uplink reception at the same time.

In addition, the determination methods of the application time of the first spatial filter used by the repeater for uplink reception is similar to those illustrated in FIG. 11-FIG. 12, so it will not be repeated here.

In an embodiment, the first spatial filter used for the downlink reception of the repeater can be determined by using the following methods:

### Method 1

The repeater determines the first spatial filter according to SSB ID. Further, the repeater uses the first spatial filter for downlink reception; wherein the first spatial filter is the same as the second spatial filter; the second spatial filter is related to the SSB ID (or, the second spatial filter is a spatial filter for receiving the SSB). For example, the repeater (NCR-MT) receives SSB information (for example, SSB #2) from the base station, and the repeater (NCR-MT) receives SSB #2 using the second spatial filter. The repeater (the NCR-Forward) uses the same spatial filter as the second spatial filter for downlink reception.

### Method 2

The repeater determines the first spatial filter according to CSI-RS ID. Further, the repeater uses the first spatial filter for downlink reception; wherein the first spatial filter is the same as the second spatial filter; the second spatial filter is related to the CSI-RS ID (or, the second spatial filter is a spatial filter for receiving the CSI-RS). For example, the repeater (NCR-MT) receives CSI-RS information (for example, CSI-RS #2) from the base station, and the repeater (NCR-MT) receives CSI-RS #2 using the second spatial filter. The repeater (the NCR-Forward) uses the same spatial filter as the second spatial filter for downlink reception.

### Method 3

The repeater determines the first spatial filter according to the TCI state ID. Further, the repeater uses the first spatial filter for downlink reception; wherein the first spatial filter is the same as the second spatial filter; the second spatial filter is related to the TCI state ID (or, the second spatial filter is a spatial filter for receiving the downlink reference signal related to the TCI state; or, the second spatial filter is a spatial filter for receiving the uplink reference signal related to the TCI state). Further, the TCI state information may be an uplink TCI state, a downlink TCI state or a joint TCI state. For example, the repeater (NCR-MT) receives TCI state information (for example, TCI state #2) from the base station, and the repeater (NCR-MT) receives SSB #2 related to TCI state #2 using the second spatial filter. The repeater (the NCR-Forward) uses the same spatial filter as the second spatial filter for downlink reception.

It is further understood that as the second spatial filter is a spatial filter for receiving the uplink reference signal related to the TCI state, a condition where this method can be used is that the repeater supports beam correspondence. The repeater supporting beam correspondence can be understood as repeater supporting beam correspondence in FR2. Or, the repeater supporting beam correspondence can be understood as the repeater having the capability to select/determine the downlink receiving beam (spatial filter) according to the uplink transmitting beam (spatial filter). The reason why the repeater needs to support the beam correspondence is that only the repeater that supports the beam correspondence can perform beam referencing by using reciprocity.

In addition, the determination methods of the application time of the first spatial filter used by the repeater for downlink reception is similar to those illustrated in FIG. 11-FIG. 12, so it is not be repeated here.

In an embodiment, optionally the first spatial filter used for the uplink forwarding of the repeater is determined by the following methods:

### Method 1

The repeater determines the first spatial filter according to the SRS ID. Further, the repeater uses the first spatial filter for uplink forwarding; wherein the first spatial filter is the same as the second spatial filter; the second spatial filter is related to the SRS ID (or, the second spatial filter is a spatial filter for transmitting the SRS). For example, the repeater (NCR-MT) receives SRS information (for example, SRS #2) from the base station, and the repeater (NCR-MT) transmits SRS #2 using the second spatial filter. The repeater (the NCR-Forward) uses the same spatial filter as the second spatial filter for uplink forwarding.

### Method 2

The repeater determines the first spatial filter according to the spatial relation indication. Further, the repeater uses the first spatial filter for uplink forwarding; wherein the first spatial filter is the same as the second spatial filter; the second spatial filter is related to the spatial relation indication (or, the second spatial filter is a spatial filter for transmitting the uplink reference signal corresponding to the spatial relation; or, the second spatial filter is a spatial filter for receiving the downlink reference signal corresponding to the spatial relation). For example, the repeater (NCR-MT) receives the spatial relation information (e.g., Spatial Relation #1) from the base station, and the repeater (NCR-MT) uses the second spatial filter to transmit the SRS related to Spatial Relation #1. The repeater (NCR-Forward) uses the same spatial filter as the second spatial filter for uplink forwarding.

It is further understood that as the second spatial filter is a spatial filter for receiving the downlink reference signal corresponding to the spatial relation, a condition where this method can be used is that the repeater supports beam correspondence. The repeater supporting beam correspondence can be understood as repeater supporting beam correspondence in FR2. Or, the repeater supporting beam correspondence can be understood as the capability parameter beamCorrespondenceWithoutUL-Beam-Sweeping reported by the repeater being 1. The reason why the repeater needs to support the beam correspondence is that only the repeater that supports the beam correspondence can perform beam referencing by using reciprocity.

### Method 3

The repeater determines the first spatial filter according to SSB ID. Further, the repeater uses the first spatial filter for uplink forwarding; wherein the first spatial filter is the same as the second spatial filter; the second spatial filter is related to the SSB ID (or, the second spatial filter is a spatial filter for receiving the SSB). For example, the repeater (NCR-MT) receives SSB information (for example, SSB #2) from the base station, and the repeater (NCR-MT) receives SSB #2 using the second spatial filter. The repeater (the NCR-Forward) uses the same spatial filter as the second spatial filter for uplink forwarding.

It is further understood that a condition where this method can be used is that the repeater supports beam correspondence. The repeater supporting beam correspondence can be understood as repeater supporting beam correspondence in FR2. Or, the repeater supporting beam correspondence can be understood as the capability parameter beamCorrespondenceWithoutUL-BeamSweeping reported by the repeater being 1. The reason why the repeater needs to support the beam correspondence is that only the repeater that supports the beam correspondence can perform beam referencing by using reciprocity.

### Method 4

The repeater determines the first spatial filter according to CSI-RS ID. Further, the repeater uses the first spatial filter for uplink forwarding; wherein the first spatial filter is the same as the second spatial filter; the second spatial filter is related to the CSI-RS ID (or, the second spatial filter is a spatial filter for receiving the CSI-RS). For example, the repeater (NCR-MT) receives CSI-RS information (for example, CSI-RS #2) from the base station, and the repeater (NCR-MT) receives CSI-RS #2 using the second spatial filter. The repeater (the NCR-Forward) uses the same spatial filter as the second spatial filter for uplink forwarding.

It is further understood that a condition that this method can be used is that the repeater supports beam correspondence. The repeater supporting beam correspondence can be understood as repeater supporting beam correspondence in FR2. Or, the repeater supporting beam correspondence can be understood as the capability parameter beamCorrespondenceWithoutUL-BeamSweeping reported by the repeater being 1. The reason why the repeater needs to support the beam correspondence is that only the repeater that supports the beam correspondence can perform beam referencing by using reciprocity.

### Method 5

The repeater determines the first spatial filter according to the TCI state ID. Further, the repeater uses the first spatial filter for uplink forwarding; wherein the first spatial filter is the same as the second spatial filter; the second spatial filter is related to the TCI state ID (or, the second spatial filter is a spatial filter for receiving the downlink reference signal related to the TCI state; or, the second spatial filter is a spatial filter for transmitting the uplink reference signal related to the TCI state). Further, the TCI state information may be an uplink TCI state, a downlink TCI state or a joint TCI state. For example, the repeater (NCR-MT) receives TCI state information (for example, TCI state #2) from the base station, and the repeater (NCR-MT) receives SSB #2 related to TCI state #2 using the second spatial filter. The repeater (NCR-Forward) uses the same spatial filter as the second spatial filter for uplink forwarding.

It is further understood that as the second spatial filter is a spatial filter for receiving the downlink reference signal related to the TCI state, a condition where this method can be used is that the repeater supports beam correspondence. The repeater supporting beam correspondence can be understood as repeater supporting beam correspondence in FR2. Or, the repeater supporting beam correspondence can be understood as the capability parameter beamCorrespondenceWithoutUL-BeamSweeping reported by the repeater being 1. The reason why the repeater needs to support the beam correspondence is that only the repeater that supports the beam correspondence can perform beam referencing by using reciprocity.

In addition, the determination methods of the application time of the first spatial filter used by the repeater for uplink forwarding is similar to those illustrated in FIG. 11-FIG. 12, so it will not be repeated here.

FIG. 14 illustrates a flowchart of a method performed by a repeater according to an embodiment of the present disclosure.

In 1410, the repeater receives reference signal information from the base station.

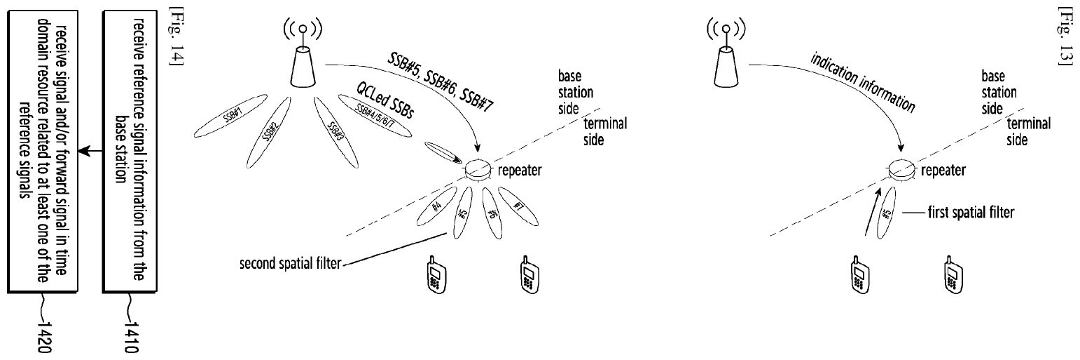

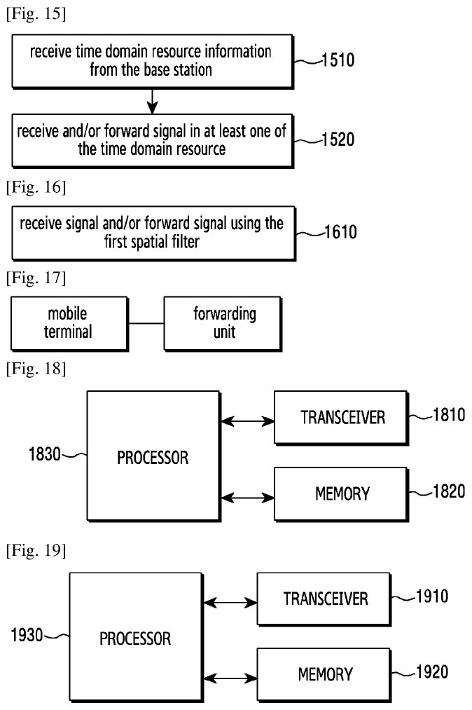

In 1420, based on the received reference signal information, the repeater receives signal and/or forwards signal in time domain resource related to at least one of the reference signals. FIG. 15 illustrates a flowchart of a method performed by a repeater according to an embodiment of the present disclosure.

In 1510, the repeater receives time domain resource information from the base station.

In 1520, the repeater receives and/or forwards signal in at least one of the time domain resources based on the received time domain resource information.

FIG. 16 illustrates a flowchart of a method performed by a repeater according to an embodiment of the present disclosure.

In 1610, the repeater receives signal and/or forwards signal using the first spatial filter.

FIG. 17 illustrates a block diagram of a repeater according to an embodiment of the present disclosure.

As illustrated in FIG. 17, a repeater according to an embodiment of the present disclosure includes a mobile terminal and a forwarding unit, wherein the mobile terminal and the forwarding unit are respectively configured to perform the above-described methods according to the embodiments of the present disclosure.

It can be understood that the reference signal information, the indication of the reference signal, the time domain resource information and the indication of the time domain resource, which are transmitted to the repeater (e.g., the NCR-MT) described in various embodiments and methods of the present disclosure, are set or configured by the base station. Furthermore, in various embodiments of the present disclosure, the repeater uses different spatial filters to forward signals in time domain resources (related to one or more reference signals). It can be understood that the spatial filters used for time domain resources related to one or more reference signals is different from each other or partially different; or it can also be understood that the number of spatial filters used for time domain resources related to one or more reference signals is smaller than the number of time domain resources related to one or more reference signals.

FIG. 18 is a block diagram of an internal configuration of a UE or a repeater, according to an embodiment.

As shown in FIG. 18, the UE or the repeater according to an embodiment may include a transceiver 1810, a memory 1820, and a processor 1830. The transceiver 1810, the memory 1820, and the processor 1830 of the UE or the repeater may operate according to a communication method of the UE or the repeater described above. However, the components of the UE or the repeater are not limited thereto. For example, the UE or the repeater may include more or fewer components than those described above. In addition, the processor 1830, the transceiver 1810, and the memory 1820 may be implemented as a single chip. Also, the processor 1830 may include at least one processor.

Furthermore, the UE or the repeater of FIG. 18 corresponds to the repeater of FIG. 17.

The transceiver 1810 collectively refers to a UE or a repeater receiver and a UE or a repeater transmitter, and may transmit/receive a signal to/from a base station or a network entity. The signal transmitted or received to or from the base station or a network entity may include control information and data. The transceiver 1810 may include a RF transmitter for up-converting and amplifying a frequency of a transmitted signal, and a RF receiver for amplifying low-noise and down-converting a frequency of a received signal. However, this is only an example of the transceiver 1810 and components of the transceiver 1810 are not limited to the RF transmitter and the RF receiver.

Also, the transceiver 1810 may receive and output, to the processor 1830, a signal through a wireless channel, and transmit a signal output from the processor 1830 through the wireless channel.

The memory 1820 may store a program and data required for operations of the UE or the repeater. Also, the memory 1820 may store control information or data included in a signal obtained by the UE. The memory 1820 may be a storage medium, such as read-only memory (ROM), random access memory (RAM), a hard disk, a CD-ROM, and a DVD, or a combination of storage media.

The processor 1830 may control a series of processes such that the UE or the repeater operates as described above. For example, the transceiver 1810 may receive a data signal including a control signal transmitted by the base station or the network entity, and the processor 1830 may determine a result of receiving the control signal and the data signal transmitted by the base station or the network entity.

FIG. 19 is a block diagram of an internal configuration of a base station or a network entity, according to an embodiment.

As shown in FIG. 19, the base station or the network entity according to an embodiment may include a transceiver 1910, a memory 1920, and a processor 1930. The transceiver 1910, the memory 1920, and the processor 1930 of the base station or the network entity may operate according to a communication method of the base station or the network entity described above. However, the components of the base station or the network entity are not limited thereto. For example, the base station or the network entity may include more or fewer components than those described above. In addition, the processor 1930, the transceiver 1910, and the memory 1920 may be implemented as a single chip. Also, the processor 1930 may include at least one processor.

Furthermore, the network entity of the FIG. 19 corresponds to the base station of FIG. 2.

The transceiver 1910 collectively refers to the base station (or the network entity receiver) and a base station (or the network entity) transmitter, and may transmit/receive a signal to/from a terminal or a network entity or a base station. The signal transmitted or received to or from the terminal or a network entity or the base station may include control information and data. The transceiver 1910 may include a RF transmitter for up-converting and amplifying a frequency of a transmitted signal, and a RF receiver for amplifying low-noise and down-converting a frequency of a received signal. However, this is only an example of the transceiver 1910 and components of the transceiver 1910 are not limited to the RF transmitter and the RF receiver.

Also, the transceiver 1910 may receive and output, to the processor 1930, a signal through a wireless channel, and transmit a signal output from the processor 1930 through the wireless channel.

The memory 1920 may store a program and data required for operations of the base station or the network entity. Also, the memory 1920 may store control information or data included in a signal obtained by the base station or the network entity. The memory 1920 may be a storage medium, such as read-only memory (ROM), random access memory (RAM), a hard disk, a CD-ROM, and a DVD, or a combination of storage media.

The processor 1930 may control a series of processes such that the base station or the network entity operates as described above. For example, the transceiver 1910 may receive a data signal including a control signal transmitted by the terminal or the network entity or the base station, and the processor 1930 may determine a result of receiving the control signal and the data signal transmitted by the terminal or the network entity or the base station.

In an aspect of the present disclosure, a method performed by a repeater in a wireless communication network is provided, the method comprising: receiving reference signal information from a base station; and receiving and/or forwarding signal in time domain resources related to at least one of reference signals, wherein at least one of the reference signals is related to the reference signal information.

In an embodiment, the method further includes determining that at least one of the reference signals corresponds to the same quasi-co-location QCL assumption.

In an embodiment, receiving and/or forwarding signal in time domain resources related to at least one of reference signals includes receiving signal in time domain resources related to at least one of the reference signals using the same spatial filter.

In an embodiment, receiving and/or forwarding signal in time domain resources related to at least one of reference signals includes forwarding signal in time domain resources related to at least one of the reference signals using different spatial filters.

In an embodiment, the number of the reference signals is less than or equal to the maximum number of reference signals for forwarding supported by the repeater.

In an embodiment, at least one of the reference signals is received using the same spatial filter.

In another aspect of the present disclosure, a method performed by a repeater in a wireless communication network is provided, the method comprising: receiving time domain resource information from a base station; and receiving and/or forwarding signal in at least one of time domain resources, wherein at least one of the time domain resources is related to the time domain resource information.

In an embodiment, the method further comprises determining that at least one of the time domain resources corresponds to the same spatial filter.

In an embodiment, receiving and/or forwarding signal in at least one of time domain resources includes receiving and/or forwarding signal in at least one of the time domain resources using the same spatial filter.

In an embodiment, receiving and/or forwarding signal in at least one of time domain resources includes receiving and/or forwarding signal in at least one of the time domain resources using different spatial filters.

In another aspect of the present disclosure, a method performed by a repeater in a wireless communication network is provided, the method comprising: receiving and/or forwarding signal using a first spatial filter; wherein the first spatial filter is related to a second spatial filter; and the second spatial filter is related to at least one of the followings: a synchronization signal block (SSB); a channel state information reference signal (CSI-RS); a sounding reference signal (SRS); a transmission configuration indicator (TCI) state; spatial relation; time domain resource; and beam information.

In an embodiment, the repeater supports beam correspondence.

In another aspect of the present disclosure, a repeater is provided, including a mobile terminal configured to receive reference signal information from a base station; and a forwarding unit configured to receive and/or forward signal in time domain resources related to at least one of reference signals, wherein at least one of the reference signals is related to the reference signal information.

In another aspect of the present disclosure, a repeater is provided, including a mobile terminal configured to receive time domain resource information from a base station; and a forwarding unit configured to receive and/or forward signal in at least one of time domain resources, wherein at least one of the time domain resources is related to the time domain resource information.

In another aspect of the present disclosure, a repeater is provided, including a mobile terminal; and a forwarding unit configured to receive and/or forward signal using a first spatial filter; wherein the first spatial filter is related to a second spatial filter; and the second spatial filter is related to at least one of the following: a synchronization signal block (SSB); a channel state information reference signal (CSI-RS); a sounding reference signal (SRS); a transmission configuration indicator (TCI) state; spatial relation; time domain resource; and beam information.

In another aspect of the present disclosure, a method performed by a base station in a wireless communication network is provided, the method comprising: transmitting reference signal information to a repeater; wherein the reference signal information is used for the repeater to receive and/or forward signal in time domain resource related to at least one of reference signals, and at least one of the reference signals is related to the reference signal information.

In another aspect of the present disclosure, a method performed by a base station in a wireless communication network is provided, the method comprising: transmitting time domain resource information to a repeater; wherein the time domain resource information is used for the repeater to receive and/or forward signal in at least one of time domain resources, and at least one of the time domain resources is related to the time domain resource information.

The various actions, acts, blocks, steps, or the like in the flow charts may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

The illustrative logical blocks, modules, and circuits described in this disclosure can be implemented with a general-purpose processor, a Digital Signal Processor (DSP), an application specific integrated circuit (application specific integrated circuit), ASIC), a Field Programmable Gate Array (FPGA) or other programmable logic devices, discrete gate or transistor logic, discrete hardware components, or any combination thereof designed to perform the functions described herein. The general-purpose processor may be a microprocessor, but in the alternative, the processor may be any conventional processor, controller, microcontroller, or state machine. The processor can also be implemented as a combination of computing devices, such as a combination of a DSP and a microprocessor, multiple microprocessors, one or more microprocessors cooperating with a DSP core, or any other such configuration.

The steps of the method or algorithm described in this disclosure can be embodied directly in hardware, in a software module performed by a processor, or in a combination of the two. The software modules may reside in RAM memory, flash memory, ROM memory, EPROM memory, EEPROM memory, registers, hard disks, removable disks, or any other form of storage media known in the art. An exemplary storage medium is coupled to the processor so that the processor can read and write information from/to the storage medium. In the alternative, the storage medium may be integrated into the processor. The processor and the storage medium may reside in the ASIC. The ASIC may reside in the user terminal. In the alternative, the processor and the storage medium may reside as discrete components in the user terminal.

In one or more exemplary designs, the functions can be implemented in hardware, software, firmware, or any combination thereof. If implemented in software, each function can be stored on or transmitted by a computer-readable medium as one or more indication or codes. Computer readable media include both computer storage media and communication media, the latter including any media that facilitates the transfer of computer programs from one place to another. Storage media can be any available media that can be accessed by general-purpose or special-purpose computers.

With reference to the drawings, the description set forth herein describes example configurations, methods and devices, and does not represent all examples that can be implemented or within the scope of the claims. As used herein, the term “example” means “serving as an example, instance or illustration”, not “preferred” or “superior to other examples”. The detailed description includes specific details in order to provide an understanding of the described technology. However, these techniques may be practiced without these specific details. In some cases, well-known structures and devices are illustrated in block diagram form to avoid obscuring the concepts of the described examples.

Although this specification contains a number of specific implementation details, these should not be construed as limitations on any invention or the scope of the claimed protection, but descriptions of specific features of specific embodiments of specific inventions. Some features described in this specification in the context of individual embodiments can also be combined in a single embodiment. On the contrary, various features described in the context of a single embodiment can also be implemented in multiple embodiments alone or in any suitable sub-combination. Furthermore, although features can be described above as functioning in some combinations, and even initially claimed as such, in some cases, one or more features from the claimed combination can be deleted from the combination, and the claimed combination can be aimed at sub-combinations or variations of sub-combinations.

It should be understood that the specific order or hierarchy of steps in the method of the present invention is an illustration of an exemplary process. Based on the design preference, it can be understood that the specific order or hierarchy of steps in the method can be rearranged to achieve the disclosed functions and effects of the present invention. The attached method claims present elements of various steps in an example order, and are not meant to be limited to the specific order or hierarchy presented, unless otherwise stated. In addition, although the elements can be described or claimed in the singular form, the plural is also contemplated unless the limitation of the singular is explicitly stated. Therefore, the present disclosure is not limited to the illustrated examples, and any device for performing the functions described herein is included in various aspects of the present disclosure.

And the text and drawings are only provided as examples to help readers understand this disclosure. They are not intended and should not be construed to limit the scope of the present disclosure in any way. Although some embodiments and examples have been provided, based on the disclosure herein, it is obvious to those skilled in the art that changes can be made to the illustrated embodiments and examples without departing from the scope of this disclosure.

1.-15. (canceled)

16. A method performed by a network-controlled repeater (NCR) in a wireless communication system, the method comprising:
receiving, from a base station (BS), information configuring a transmission configuration indicator (TCI) state associated with a quasi co-location (QCL) relationship for a reference signal;
receiving, from the BS via a control link, a first signal in a set of symbols based on the TCI state; and
receiving, from the BS via a backhaul link, a second signal in the set of symbols based on the TCI state.

17. The method of claim 16, wherein the first signal and the second signal are received simultaneously.

18. The method of claim 16, wherein the first signal includes at least one of a synchronization signal block (SSB), a channel state information reference signal (CSI-RS), or a sounding reference signal (SRS).

19. The method of claim 16,
wherein the first signal is received via the control link by an NCR mobile terminal (MT) entity included in the NCR, and
wherein the second signal is received via the backhaul link by an NCR forward (FWD) entity included in the NCR.

20. The method of claim 16, wherein the TCI state corresponds to two reference signals.

21. The method of claim 16, further comprising:
transmitting, to a user equipment (UE) via an access link, the second signal by the NCR FWD entity.

22. A method performed by a base station in a wireless communication system, the method comprising:
transmitting, to a network-controlled repeater (NCR), information configuring a transmission configuration indicator (TCI) state associated with a quasi co-location (QCL) relationship for a reference signal;
transmitting, to the NCR via a control link, a first signal in a set of symbols based on the TCI state; and
transmitting, to the NCR via a backhaul link, a second signal in the set of symbols based on the TCI state.

23. The method of claim 22, wherein the first signal and the second signal are transmitted simultaneously.

24. The method of claim 22, wherein the first signal includes at least one of a synchronization signal block (SSB), a channel state information reference signal (CSI-RS), or a sounding reference signal (SRS).

25. The method of claim 22,
wherein the first signal is transmitted via the control link to an NCR mobile terminal (MT) entity included in the NCR, and
wherein the second signal is transmitted via the backhaul link to an NCR forward (FWD) entity included in the NCR.

26. A network-controlled repeater (NCR) in a wireless communication system, the NCR comprising:
a transceiver; and
a controller coupled with the transceiver and configured to:
receive, from a base station (BS), information configuring a transmission configuration indicator (TCI) state associated with a quasi colocation (QCL) relationship for a reference signal,
receive, from the BS via control link, a first signal in a set of symbols based on the TCI state, and
receive, from the BS via a backhaul link, second signal in the set of symbols based on the TCI state.

27. The NCR of claim 26, wherein the first signal and the second signal are received simultaneously.

28. The NCR of claim 26, wherein the first signal includes at least one of a synchronization signal block (SSB), a channel state information reference signal (CSI-RS), or a sounding reference signal (SRS).

29. The NCR of claim 26,
wherein the first signal is received via the control link by an NCR mobile terminal (MT) entity included in the NCR, and
wherein the second signal is received via the backhaul link by an NCR forward (FWD) entity included in the NCR.

30. The NCR of claim 26, wherein the TCI state corresponds to two reference signals.

31. The NCR of claim 26, wherein the controller further configured to:
transmit, to a user equipment (UE) via an access link, the second signal by the NCR FWD entity.

32. A base station (BS) in a wireless communication system, the BS comprising:
a transceiver; and
a controller coupled with the transceiver and configured to:
transmit, to a network-controlled repeater (NCR), information configuring a transmission configuration indicator (TCI) state associated with a quasi co-location (QCL) relationship for a reference signal,
transmit, to the NCR via a control link, a first signal in a set of symbols based on the TCI state, and
transmit, to the NCR via a backhaul link, a second signal in the set of symbols based on the TCI state.

33. The method of claim 32, wherein the first signal and the second signal are transmitted simultaneously.

34. The method of claim 32, wherein the first signal includes at least one of a synchronization signal block (SSB), a channel state information reference signal (CSI-RS), or a sounding reference signal (SRS).

35. The method of claim 32,
wherein the first signal is transmitted via the control link to an NCR mobile terminal (MT) entity included in the NCR, and
wherein the second signal is transmitted via the backhaul link to an NCR forward (FWD) entity included in the NCR.
